(19) United States
(12) Patent Application Publication
(10) Pub. No.: US 2017/0293584 A1
(43) Pub. Date: Oct. 12, 2017

(54) CASCADED HDMI CONNECTORS

(71) Applicant: Caavo Inc, Santa Clara, CA (US)

(72) Inventors: Sharath Hariharpur Satheesh, Bangalore (IN); Conrad Savio Jude Gomes, Salcete (IN); Bitto Niclavose, Kottayam (IN)

(21) Appl. No.: 15/483,883

(22) Filed: Apr. 10, 2017

Related U.S. Application Data
(60) Provisional application No. 62/321,578, filed on Apr. 12, 2016.

(51) Int. Cl. G06F 13/40; G06F 13/42

(52) U.S. Cl. CPC G06F 13/4022; G06F 13/4286; G06F 13/4081

(57) ABSTRACT

HDMI systems, devices, circuits, and apparatuses perform functions to allow extending the number of HDMI inputs for an HDMI device using cascaded HDMI extenders. HDMI extenders are mechanically coupled and decoupled to an HDMI device such as an HDMI switch or sink device. HDMI extenders include HDMI input ports to receive HDMI signals and include connectors to receive and transmit HDMI signals as well as non-HDMI signals for configuration and control of the HDMI extenders. One or more mechanically coupled HDMI extenders are configured by the HDMI device based on information received from HDMI source devices connected to the HDMI extenders and to the HDMI device. The HDMI extenders select between HDMI signals received from their input ports or HDMI signals received from their connectors, and provide the selected HDMI signals to the HDMI device. HDMI extenders are configured to be cascaded in any number to increase HDMI source availability.

### CROSS-REFERENCE TO RELATED APPLICATION(S)

This application claims priority to U.S. Provisional Patent Application No. 62/321,578, filed Apr. 12, 2016, and entitled “CASCADED HDMI CONNECTORS,” the entirety of which is incorporated by reference herein.

### BACKGROUND

### Technical Field

The subject matter described herein relates to input extensions for devices.

### Description of Related Art

The number of high-definition multimedia interface (HDMI) devices in a typical living room is increasing. HDMI devices are categorized as source devices, repeater/switch devices, and sink devices. In a typical HDMI chain, the number of source devices is generally greater than the number of repeater/switch devices, and the number of repeater/switch devices is generally greater than or equal to the number of sink devices. Sink devices are usually limited to a television (TV) or a projector. However, source devices span across a wide variety of devices, such as set-top boxes, Blu-ray® players, Internet streaming devices, video game consoles, media players, cameras, computers, tablets, phones, etc. The repeater/switch devices and the sink devices include a limited set of HDMI inputs. If the number of source devices exceeds the number of inputs that are included in the repeater/switch device and the sink devices, then the HDMI chain gets complex, which can result in multiple HDMI features being inoperable.

### BRIEF SUMMARY

Methods, systems, devices, and apparatuses are described for extending the number of inputs for devices and systems, such as a HDMI devices and systems, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of an HDMI system, in accordance with an embodiment.

FIG. 2 shows a block diagram of an HDMI switch, in accordance with an embodiment.

FIG. 3 shows a flowchart of a method for cascading HDMI inputs, in accordance with an embodiment.

FIG. 4 shows a block diagram of a system portion of an HDMI extender, in accordance with an embodiment.

FIG. 5 shows a block diagram of an HDMI extender system, in accordance with another embodiment.

FIG. 6 shows a flowchart of a method for configuring an HDMI extender, in accordance with an embodiment.

FIG. 7 shows a flowchart of a method for cascading HDMI inputs, in accordance with an embodiment.

FIG. 8 shows a flowchart of a method for configuring an HDMI extender, in accordance with an embodiment.

FIG. 9 shows a flowchart of a method for configuring an HDMI extender, in accordance with an embodiment.

FIG. 10 shows a flowchart of a method for HDMI source detection, in accordance with an embodiment.

FIG. 11 shows a block diagram of an HDMI system with cascaded HDMI extenders, in accordance with an embodiment.

FIG. 12 shows a flowchart of a method for cascading HDMI inputs, in accordance with an embodiment.

FIG. 13 is a block diagram of an example computer system in which embodiments may be implemented.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives such as “substantially,” “approximately,” and “about” modifying a condition or relationship characteristic of a feature or features of an embodiment of the disclosure, are understood to mean that the condition or characteristic is defined to be within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Still further, it should be noted that the drawings/figures are not drawn to scale unless otherwise noted herein.

Any section/subsection headings provided herein are not intended to be limiting. Embodiments are described throughout this document, and any type of embodiment may be included under any section/subsection. Furthermore, it is contemplated that the disclosed embodiments may be combined with each other in any manner. That is, the embodiments described herein are not mutually exclusive of each other and may be practiced and/or implemented alone, or in any combination.

Various example embodiments are described in the following Sections. In particular, example embodiments are described. This description includes subsections for HDMI switch embodiments, HDMI extender embodiments, and additional multi-cascade embodiments. The example embodiments are followed by further example embodiments and advantages are described, and subsequently an example computing device implementation is described. Finally, some concluding remarks are provided. It is noted that the division of the following description generally into Sections and/or subsections is provided for ease of illustration, and it is to be understood that any type of embodiment may be described in any Section or subsection.

### II. Example Embodiments

The example techniques and embodiments described herein may be adapted to various types of systems and devices, for example but without limitation, HDMI-enabled devices, such as HDMI switches and/or repeaters, communication devices (e.g., cellular and smart phones, etc.), computers/computing devices (e.g., laptops, tablets, desktops, etc.), computing systems, electronic devices, gaming consoles, home electronics and entertainment devices (e.g., home theater systems, stereos, televisions, media players, set top boxes, DVD players, etc.), and/or the like. It is contemplated herein that in various embodiments and with respect to the illustrated figures of this disclosure, one or more components described and/or shown may not be included and that additional components may be included. It is also contemplated herein that in various embodiments and with respect to the illustrated figures of this disclosure, one or more components described and/or shown may be electrically—and/or communicatively-coupled to other components in alternative and/or equivalent manners.

As noted above, repeater/switch devices and systems, as well as sink devices and systems, include a limited set of HDMI inputs. When the number of source devices exceeds the number of inputs that are included in the repeaters/switches or the sinks, then the HDMI chain gets complex, which can result in multiple HDMI features being inoperable. Embodiments and techniques described herein are directed to systems, devices, and/or the like, that can be input-extended to include any number of input ports. Although the described embodiments are provided in the context of HDMI, e.g., extending HDMI input ports through cascading, the embodiments are not so limited and may be adapted to other electronics/communications protocols as will be understood by one of ordinary skill in the relevant art(s) having the benefit of this disclosure. Furthermore, the described techniques may be utilized with HDMI switching and/or HDMI input extender devices/systems (further details below), however the contemplated embodiments may be used with additional types of devices and systems for which extending or cascading inputs provides additional flexibility to add any number of inputs while still adhering to electronics/communications protocols and feature/function provisions.

For clarity of description herein, illustrated HDMI systems and devices may be switching devices such as an audio/video (AV) receiver, an AV repeater, an AV switch and/or the like. The systems and devices may also be sink devices (e.g., a projector, a monitor, or a TV) or any other device that includes an input port, such as an HDMI input port. Systems and devices, including circuits thereof, may be enabled in various ways for cascading inputs to extend the number of input ports available, according to embodiments.

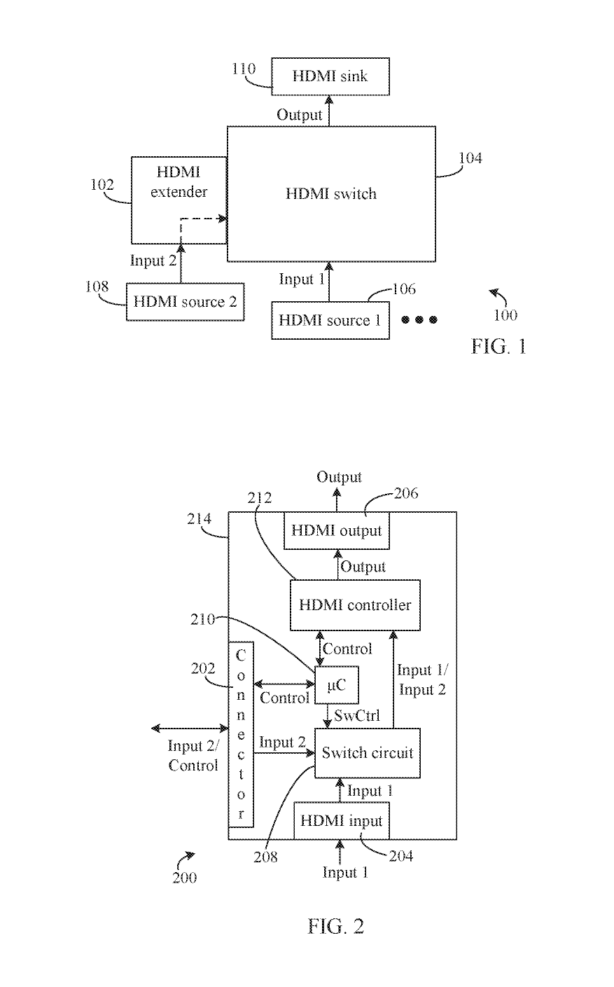

For example, FIG. 1 shows a block diagram of an HDMI system 100 (“system 100”) with a cascaded input extension, according to an embodiment. As shown in FIG. 1, system 100 includes an HDMI extender 102 and an HDMI switch 104. HDMI switch 104 may represent any type of switching device or system described herein.

As shown, HDMI switch 104 is configured to receive an input “Input 1” at an input port (described in further detail below) that may comprise HDMI input signals, such as from an HDMI source 1 device 106, and to provide an output “Output 1” at an output port (described in further detail below) that may comprise HDMI output signals, e.g., to an HDMI sink device 110. In embodiments, HDMI switch 104 may be configured to receive additional inputs (not shown for illustrative clarity and brevity of description).

It is also contemplated herein that a sink device, e.g., HDMI sink device 110 which may be a TV, display, projector, or the like, may take the place of HDMI switch 104, in embodiments, and in such cases, the output shown for HDMI switch 104 may or may not be included. That is, zero or more outputs, such as HDMI outputs, are contemplated herein for sink and switching devices and systems.

HDMI extender 102 and HDMI switch 104 are configured to be mechanically and/or communicatively coupled and decoupled in embodiments, as described in further detail below. The illustrated embodiment of system 100 in FIG. 1 shows HDMI extender 102 and HDMI switch 104 as being mechanically and communicatively coupled.

According to embodiments, HDMI extender 102 is an add-on input module or an add-on module configured to provide extended input ports for HDMI switch 104 through cascading. HDMI extender 102 includes circuitry, processing/controller devices, and/or signal switches/selectors, in embodiments as described below. HDMI extender 102 is configured to enable an input “Input 2” received by HDMI extender 102 from an HDMI source 2 device 108 to be provided to HDMI switch 104 via their mechanical and communicative coupling to affect input extension for HDMI switch 104. That is, while only a single HDMI extender 102 is shown in system 100, additional cascaded HDMI extenders 102 are contemplated in embodiments as described in further detail herein to enable any number of inputs to be received by HDMI switch 104, even though HDMI switch 104 has a hardware-limited number of input ports (e.g., 1 as shown).

In embodiments, communication between a given HDMI extender 102 and another HDMI extender 102 and/or HDMI switch 104 may be wireless or by hard contacts that allow communication and mechanical coupling/decoupling. HDMI extender 102 and HDMI switch 104 are configured to include HDMI signals, configuration information, and control signals in their communications, as described herein. In embodiments, HDMI extender 102 may be configured by HDMI switch 104 to appropriately handle HDMI functionality and operations for connected devices such that HDMI features for any connected device are available to the user regardless of how many HDMI extenders 102 are cascaded. In this way, any number of additional source devices may be connected to HDMI switch 104 to provide input signals via an additional number of HDMI extenders 102.

Accordingly, the described techniques and embodiments allow for flexibility to add any number of inputs while still adhering to electronics/communications protocols and feature/function provisions. Thus, a user's experience is improved for using multiple source devices without foregoing desired features of these devices.

For instance, methods, systems, devices, and apparatuses are provided for cascading HDMI inputs to provide input extensions. A method in an HDMI system in accordance with an example aspect is described. The method includes receiving configuration information from a switching device coupled to an HDMI extender via a first connector, the HDMI extender comprising a first HDMI input port and the switching device comprising a second HDMI input port, and configuring the HDMI extender based on the configuration information.

In embodiments, the method further includes providing HDMI signals and non-HDMI signals between the switching device and the HDMI extender via a communication connection of the first connector.

In an embodiment of the method, the configuration information includes at least one of: a number of devices coupled to the switching device, a current state of a device coupled to the switching device, a physical address of each of the devices coupled to the switching device, or a logical address of each of the devices coupled to the switching device.

In an embodiment of the method, the configuration information is determined at the switching device based on at least one of an HDMI signal or a non-HDMI signal provided from the HDMI extender via the first connector. In another embodiment of the method, the at least one of the HDMI signal or the non-HDMI signal originates from another HDMI extender communicatively coupled to the switching device via the HDMI extender.

In an embodiment of the method, configuring the HDMI extender includes configuring a selector of the HDMI extender to provide a first signal path from the first HDMI input port or a second signal path from a second connector of the HDMI extender. In another embodiment, the method further comprises providing, subsequent to configuring the selector of the HDMI extender, an HDMI signal via the selector and the first connector from one of the first HDMI input port or the second connector.

In accordance with another aspect, an HDMI device is described. The HDMI device includes an HDMI input port, a first connector, an input switch circuit, and a controller circuit. The HDMI input port is configured to receive first HDMI signals, and the first connector is configured to receive second HDMI signals, and to transmit non-HDMI signals. The input switch circuit is configured to provide switch output signals as one of the first HDMI signals received from the HDMI input port or the second HDMI signals received from the first connector. The controller circuit is configured to receive the non-HDMI signals, and to control operations of the input switch circuit according to a control signal based at least in part on the non-HDMI signals.

In an embodiment, the HDMI device is part of an HDMI extender, and the HDMI device further includes a second connector configured to receive and transmit the non-HDMI signals, and to transmit the switch output signals. In the embodiment, the first connector is configured to receive the non-HDMI signals. In an embodiment of the HDMI device, the controller circuit is configured to control operations of the input switch circuit based on the control signal by generating the control signal, and providing the control signal to the input switch circuit to activate to provide the switch output signals according to the control signal.

In an embodiment of the HDMI device, the controller circuit is configured to receive configuration information as one of the non-HDMI signals that include at least one of a number of devices coupled to the switching device, a current state of a device coupled to the switching device, a physical address of each of the devices coupled to the switching device, or a logical address of each of the devices coupled to the switching device. In the embodiment, the controller circuit is configured to set one or more portions of the controller circuit to operate according to the configuration information.

In an embodiment, the HDMI device further includes source device detection circuitry that is configured to detect a presence of an HDMI source device on the HDMI input port, and to provide an indication of the presence to the controller circuit.

In an embodiment of the HDMI device, the controller circuit is further configured to perform at least one HDMI protocol function, based on received configuration information, for an HDMI source device connected to the HDMI input port, that includes +5V detection, hot plug detection and toggle, physical address allocation, extended display identification data handling, consumer electronics control, display data channel, or device information retrieval.

In an embodiment, the HDMI device is part of an HDMI switch, and the HDMI device further includes an HDMI control circuit that is configured to provide the non-HDMI signals to the controller circuit, and to receive the switch output signals. In the embodiment, the HDMI device also includes an HDMI output port configured to provide the switch output signals for an HDMI sink device. In the embodiment of the HDMI device, the controller circuit is configured to provide the non-HDMI signals from the HDMI control circuit to one or more HDMI extenders communicatively coupled via the first connector.

In accordance with yet another aspect, an HDMI system is described. The HDMI system includes an HDMI input port and at least one processing circuit communicatively coupled to the HDMI input port. The processing circuit(s) is configured to receive configuration information from an HDMI controller that is external to the HDMI system, and to perform HDMI protocol functions with an HDMI source device connected to the HDMI input port according to the configuration information.

In an embodiment, the HDMI system includes a first connector that is communicatively coupled to the at least one processing circuit and to the HDMI input port, and that is configured to enable mechanical coupling and decoupling between the HDMI system and an HDMI switch comprising the HDMI controller, and to provide output HDMI signals to the HDMI switch. The at least one processing circuit is configured to receive the configuration information via the first connector, according to the embodiment.

In an embodiment, the HDMI system includes a second connector that is communicatively coupled to the at least one processing circuit and to the first connector, and that is configured to enable mechanical coupling and decoupling between the HDMI system and another HDMI system that includes another HDMI input port, and to receive first HDMI signals from the other HDMI system. In the embodiment, the HDMI input port is configured to receive second HDMI signals, and the HDMI system further includes an HDMI signal selector configured to select the first HDMI signals or the second HDMI signals as the output HDMI signals based on a control signal from the at least one processing circuit.

In an embodiment, the HDMI system includes a first connector that is communicatively coupled to the at least one processing circuit and to the HDMI input port, and that is configured to enable wireless HDMI communications between the HDMI system and an HDMI switch comprising the HDMI controller to provide an HDMI signal from the HDMI input port to the HDMI switch.

Further example techniques and embodiments, and variations thereof, will be apparent to one of skill in the relevant art(s) having the benefit of the follow description.

A. Example HDMI Switch Embodiments

As noted above, systems, devices, and circuits for cascading inputs to extend the number of input ports available, such as in an HDMI switch and respective components thereof, may be configured in various ways to perform the techniques described herein.

In embodiments, by way of illustrative example and not limitation, an HDMI switch or equivalent system/device may be configured to act as, and/or perform one or more functions of, an HDMI sink device in that one or more input signals may be received. For instance, an HDMI switch may include one or more input ports that are configured to act as input ports for connecting HDMI source devices via connector cables. As noted above, however, the number of input ports for a given system/device is fixed. In accordance with the embodiments herein, an HDMI switch or similar system/device may be configured to connect to one or more HDMI extenders, as described in system 100 of FIG. 1, to cascade input ports and extend the number of signals that may be provided to the HDMI switch.

For example, FIG. 2 shows a block diagram of an HDMI system 200 that includes an HDMI switch 214, in accordance with an embodiment. HDMI system 200 and HDMI switch 214 may respectively be further embodiments of system 100 and HDMI switch 104 in FIG. 1. HDMI switch 214 includes a connector 202, an HDMI input port (“input port”) 204, and an HDMI output port (“output port”) 206. HDMI switch 214 also includes an input switch circuit 208, a controller circuit 210, and an HDMI controller 212. Input port 204 and output port 206 are ports or sockets into which a plug of an HDMI cable may be inserted to make a connection between an HDMI source device and an HDMI switch/sink device respectively. In sink device embodiments, HDMI switch 214 may exclude output port 206. HDMI switch 214 may also be an audio/video (AV) receiver, an AV repeater, an AV switch, and/or the like in various embodiments.

In the illustrated embodiment of FIG. 2, HDMI controller 212 is an HDMI controller circuit. HDMI controller 212 is configured to enforce adherence to the HDMI specification for HDMI switch 214 and/or the source devices and/or sink devices coupled thereto. For instance, HDMI controller 212 is configured to receive and transmit HDMI signals according to the HDMI specification.

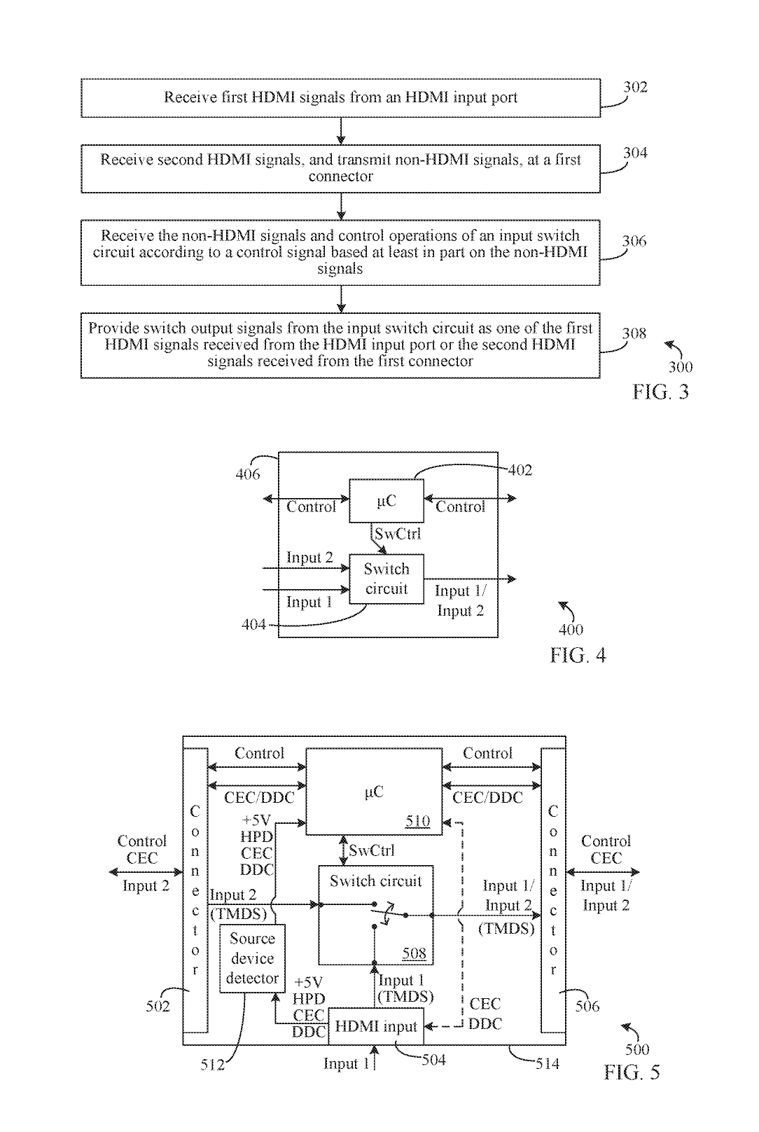

Referring also to FIG. 3, a flowchart 300 for cascading HDMI inputs is shown, according to an example embodiment. For purposes of illustration, flowchart 300 of FIG. 3 is described with respect to HDMI switch 214 of FIG. 2 and its subcomponents, and also with reference to system 100 in FIG. 1. That is, HDMI switch 214 of FIG. 2 may perform various functions and operations in accordance with flowchart 300 for cascading HDMI inputs from HDMI extenders 102 of system 100 in FIG. 1. Further structural and operational examples will be apparent to persons skilled in the relevant art(s) based on the following description. Flowchart 300 is described as follows.

In step 302, first HDMI signals are received from an HDMI input port. For instance, HDMI controller 212 is configured to receive HDMI inputs received at input port 204 (Input 1). HDMI controller 212 is also configured to transmit HDMI outputs via output port 206 (Output).

In step 304, second HDMI signals are received, and non-HDMI signals are transmitted, at a first connector. For instance, HDMI controller 212 is configured to receive HDMI inputs that are received at connector 202 (Input 2). In embodiments, HDMI inputs that are received at connector 202 are provided to HDMI controller 212 via input switch circuit 208. According to the described embodiments and techniques, HDMI controller 212 is also configured to provide and receive control and configuration information (e.g., non-HDMI signals) to/from HDMI input extenders via connector 202, such as HDMI extender 102 of system 100 in FIG. 1, as well as controller circuit 210. Example implementations to provide and receive such non-HDMI signals for the control and configuration information include, but are not limited to, standard communication buses, such as inter-integrated circuit (I2C) buses, universal asynchronous receiver/transmitter (UART), serial peripheral interface (SPI) buses, etc., and HDMI controller 212 is configured to provide and receive non-HDMI signals using these protocols. In accordance with another embodiment, the non-HDMI control signals may be transmitted and/or received via a wireless connection (e.g., Bluetooth®, Wi-Fi®, ZigBee®, and/or any other radio-frequency (RF) based on a wireless communication protocol (as opposed to using a wired communication protocol).

A “connector,” as used herein, may refer to a hardware connection such as an electrically conductive element or a software connection, as well as hardware interfaces for wireless data exchange, for the transfer of data, instructions, and/or information, according to embodiments. Connector 202 is configured to be coupled an HDMI extender (as described above and in further detail below with reference to FIG. 5) that includes an HDMI input port. Connector 202 may be configured to mechanically couple/decouple from HDMI extenders providing flexibility to cascade any number of HDMI extenders to HDMI switch 214. When the HDMI input of an HDMI extender coupled to connector 202 is selected using input switch circuit 208, as described herein, audio and/or video signals (e.g., HDMI signals) originating from a source device coupled to the HDMI extender are provided to HDMI controller 212, and HDMI controller 212 provides the audio and/or video signals to HDMI output port. In accordance with an embodiment, connector 202 may be a combination of an HDMI connector and another connector (e.g., a mini-connector) for conveying non-HDMI control signals in addition to HDMI signals.

A “switch circuit” as described herein (including a “selector”) may be a standard switch, e.g., a single-pole/single-throw switch, a single-pole/double-throw switch, etc., a field effect transistor (FET) or other type of transistor, a multiplexor, combinatorial logic, and/or other equivalent components, including combinations thereof, configured to selectively provide signals in a circuit. In embodiments, switch circuits may be normally-open (NO) or normally closed (NC). In accordance with an embodiment, input switch circuit 208 is a digital video interface (DVI) switch and/or an HDMI switching circuit. Input switch circuit 208 may be configured to select between one of the HDMI input signal on input port 204 of HDMI switch 214 (Input 1) or the HDMI input signal on connector 202 (Input 2) from an HDMI extender. When input port 204 of HDMI switch 214 is selected (or switched to), audio and/or video signals originating from a source device coupled thereto (e.g., HDMI signals, Input 1) are provided to HDMI controller 212, and HDMI controller 212 provides the audio and/or video signals for Input 1 to output port 206 as Output. When connector 202 of HDMI switch 214 is selected (or switched to), audio and/or video signals originating from a source device coupled thereto (e.g., HDMI signals, Input 2 from a source device connected to an HDMI extender) are provided to HDMI controller 212, and HDMI controller 212 provides the audio and/or video signals for Input 2 to output port 206 as Output.

Controller circuit 210 may be a microcontroller, a microprocessor executing software, a system on a chip (SoC), application-specific integrated circuit (ASIC) or other integrated circuit (IC), field-programmable gate array (FPGA), and/or the like, that manages HDMI functionality for each HDMI extender (and/or source device coupled thereto) coupled to HDMI switch 214. In embodiments, controller circuit 210 may include processing and memory components.

Controller circuit 210 is configured to enable and/or regulate HDMI functionalities of its own and those associated with each HDMI extender connected to HDMI switch 214. For instance, controller circuit 210 is configured to provide configuration and/or control signals, received thereby from HDMI controller 212, to HDMI extenders (e.g., as pass-through or pass-along signals), and/or to receive configuration and/or control signals from HDMI extenders, in embodiments. Information received in configuration and/or control signals may be stored by controller circuit 210 to configure HDMI switch 214 to properly handle HDMI functionality of coupled devices, as well as to map functionality, configurations, and/or states of coupled devices and HDMI extenders. In embodiments, HDMI extenders may be configured to handle HDMI functionalities for specific HDMI sources connected thereto based on the configuration and/or control signals.

Examples of HDMI functionalities include, but are not limited to, +5V detection (which may be used to determine if a source device is connected and/or powered on), hot plug detection (HPD), physical address allocation (which may be unique for every connected source device for consumer electronic control (CEC) to function), extended display identification data (EDID) handling, CEC functionality (e.g., active source signal handling, remote pass through signal handling, etc.), device information retrieval via CEC (e.g., using Vendor identification (ID) or on-screen display (OSD) name), display data channel (DDC) (e.g., for exchanging capabilities between source and sink devices), etc. It is noted that the HDMI functionalities associated with each HDMI extender may not be mutually exclusive with respect to each other, and one or more HDMI extenders may have functionalities serviced simultaneously.

Referring again to flowchart 300 of FIG. 3, in step 306, the non-HDMI signals are received, and operations of an input switch circuit are controlled according to a control signal based at least in part on the non-HDMI signals. For instance, controller circuit 210 is also configured to control the activation of input switch circuit 208. Controller circuit 210 may utilized the configuration and/or control signals to activate and/or deactivate input switch circuit 208 via a switch control signal (SwCtrl).

In step 308, switch output signals are provided from the input switch circuit as one of the first HDMI signals received from the HDMI input port or the second HDMI signals received from the first connector. For example, based on received configuration and/or control information, HDMI controller 212 may determine that an HDMI source connected at input port 204 is active and/or selected for operation by a user, and a control signal to this effect may be provided to controller circuit 210 which in turn provides an appropriate switch control signal SwCtrl to input switch circuit 208 to activate input switch circuit 208 for a signal path from input port 204 to HDMI controller 212 for Input 1 via input switch circuit 208.

In other embodiments, based on received configuration and/or control information, HDMI controller 212 may determine that an HDMI source connected via connector 202 is active and/or selected for operation by a user, and a control signal to this effect may be provided to controller circuit 210 which in turn provides an appropriate switch control signal SwCtrl to input switch circuit 208 to activate input switch circuit 208 for a signal path from connector 202 to HDMI controller 212 for Input 2 via input switch circuit 208.

B. Example HDMI Extender Embodiments

As previously noted, systems, devices, and circuits for cascading inputs to extend the number of input ports available, such as in an HDMI input extender (HDMI extender), and respective components thereof, may be configured in various ways to perform the techniques described herein.

In HDMI switch 214 of FIG. 2 described above, controller circuit 210 is configured to exchange non-HDMI signals with an HDMI extender via connector 202, as well as with HDMI controller 212 which is also a component of HDMI switch 214. According to the embodiments described in this subsection, a controller circuit of an HDMI extender may be configured to exchange non-HDMI signals with HDMI extenders via two connectors of the HDMI extender, e.g., in a cascaded configuration.

FIG. 4 shows a block diagram of a portion of an HDMI extender system 400, in accordance with an embodiment. HDMI extender system 400 includes an HDMI extender 406, a controller circuit 402, and an input switch circuit 404 which may respectively be further embodiments of HDMI extender 102 of FIG. 1 and controller circuit 210 and input switch circuit 208 of HDMI switch 214 of FIG. 2.

Input switch circuit 404 may be similarly configured as described above for input switch circuit 208. For example, input switch circuit 404 may receive two (or more) inputs (e.g., as shown, HDMI Input 1 and HDMI Input 2) and select, or provide a path for, one of the inputs to be the output of the switch circuit. The output of input switch circuit 404 is determined based on a switch control signal (SwCtrl) from controller circuit 402. Controller circuit 402 may be similarly configured as described above for control circuit 210. That is, controller circuit 402 is configured to control input switch circuit 404 and to enable and/or regulate HDMI functionalities of its own and those associated with each HDMI extender connected to HDMI extender 406. For instance, controller circuit 402 is configured to provide configuration and/or control signals, received thereby from an HDMI controller, e.g., of an external HDMI switch, to HDMI extenders (e.g., as pass-through or pass-along signals), and/or to receive configuration and/or control signals from HDMI extenders, in embodiments, which may be provided to the HDMI controller, e.g., of the external HDMI switch.

However, in embodiments, HDMI extender 406 is configured to be mechanically coupled and decoupled with external devices such as a separate, external HDMI switch. Accordingly, controller circuit 402 is configured to receive and transmit non-HDMI signals, such as Control signals illustrated (which may include configuration information), to systems and/or devices that are external to HDMI extender 406, as described in further detail below.

For example, FIG. 5 shows a block diagram of an HDMI extender system 500 that includes an HDMI extender 514, in accordance with another embodiment. HDMI extender system 500 and HDMI extender 514 may respectively be further embodiments of HDMI extender system 400 and HDMI extender 406 in FIG. 4. HDMI extender 514 includes a connector 502, an HDMI input port (“input port”) 504, and a connector 506. HDMI extender 514 also includes an input switch circuit 508, a controller circuit 510, and a source device detector 512. Input port 504 is a port or connector into which an HDMI cable may be inserted to make a connection between an HDMI source device and an HDMI switch/sink device respectively, and to the extent an HDMI source may be connected to HDMI extender 514 via input port 504, HDMI extender 514 acts as a sink device in this capacity. In accordance with an embodiment, input switch circuit 508 is a digital video interface (DVI) switch and/or an HDMI switching circuit.

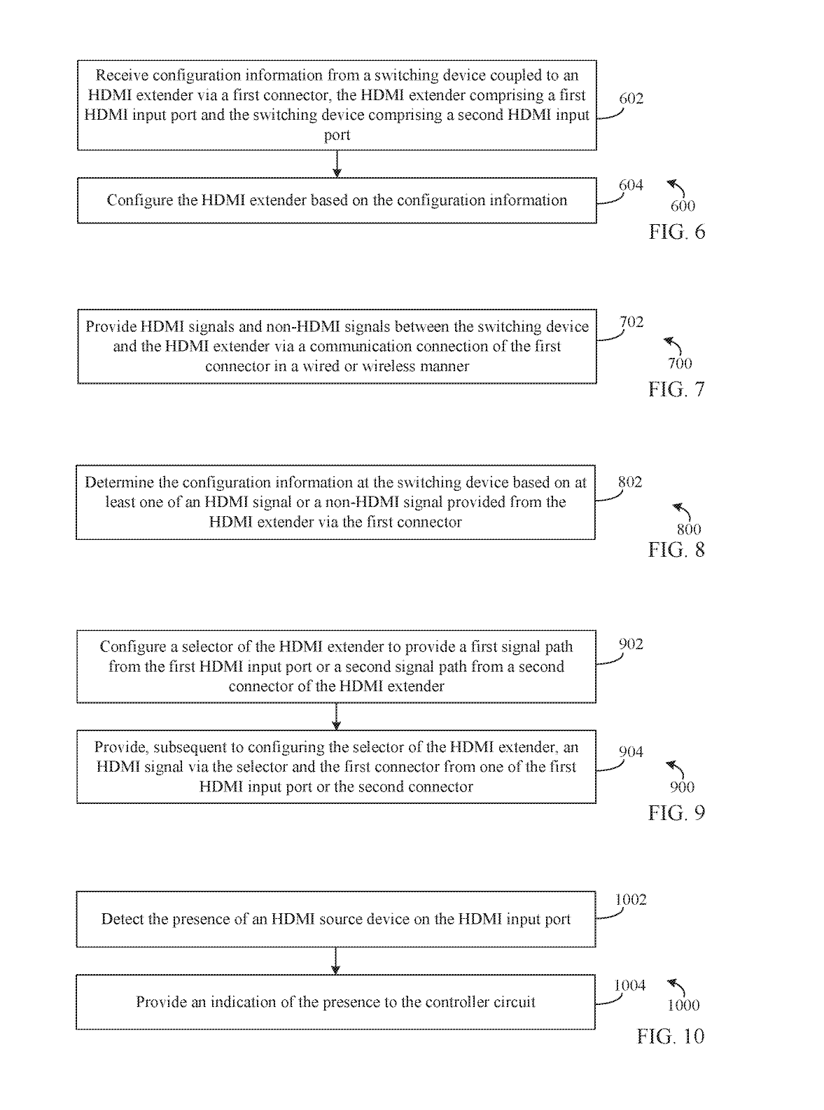

Referring also to FIG. 6, FIG. 7, and FIG. 8, a flowchart 600, a flowchart 700, and a flowchart 800 for cascading HDMI inputs are shown, respectively, according to example embodiments. For purposes of illustration, flowchart 600, flowchart 700, and flowchart 800 are described with respect to HDMI extender 514 of FIG. 5 and its subcomponents, and also with reference to HDMI switch 214 in FIG. 2. That is, HDMI extender 514 of FIG. 5 may perform various functions and operations in accordance with flowchart 600, flowchart 700, and/or flowchart 800 for cascading HDMI inputs as described herein. Further structural and operational examples will be apparent to persons skilled in the relevant art(s) based on the following description. Flowchart 600, flowchart 700, and flowchart 800 are described as follows.

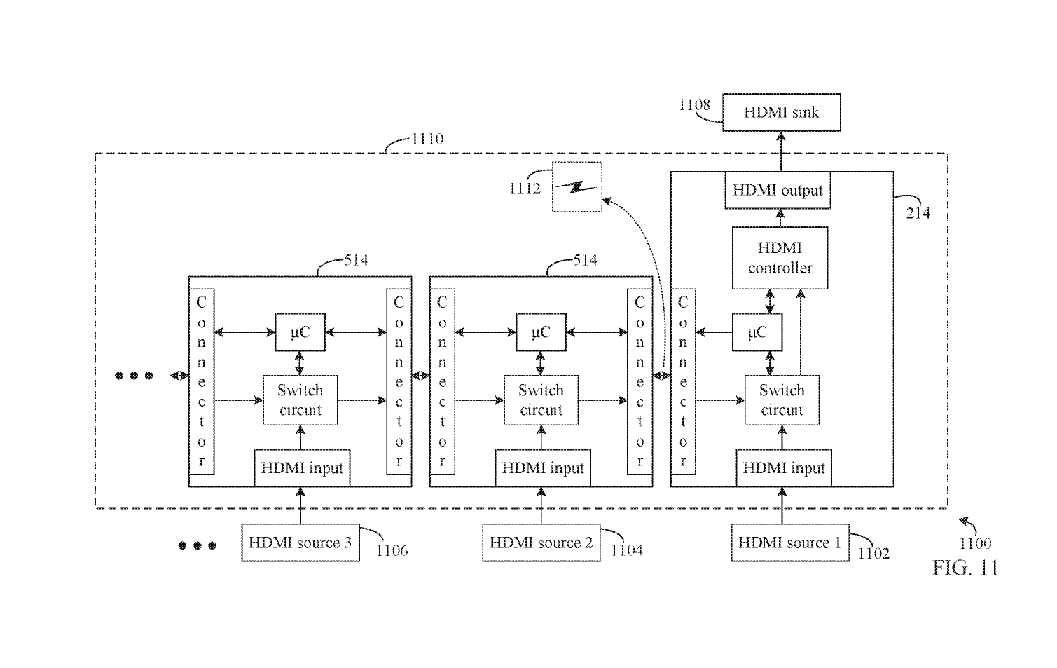

With respect to flowchart 600, in step 602, configuration information is received from a switching device coupled to an HDMI extender via a first connector, the HDMI extender comprising a first HDMI input port and the switching device comprising a second HDMI input port. For instance, referring back to FIG. 2, HDMI controller 212 is configured to enforce adherence to the HDMI specification for HDMI switch 214 (i.e., a switching device) and/or the source devices and/or sink devices coupled thereto. Additionally, an HDMI extender connected to an HDMI switch, e.g., HDMI extender 514 connected to HDMI switch 214 in a similar manner as illustrated in FIG. 1 and as shown in further detail in FIG. 11, may be configured by an HDMI controller such as one in an HDMI switch 214 (i.e., a switching device). In step 602, with reference to FIG. 5, HDMI extender 514 is configured to receive configuration information from an HDMI switch to which HDMI extender 514 is coupled via connector 506.

Referring to flowchart 700, in step 702, HDMI signals and non-HDMI signals are provided between the switching device and the HDMI extender via a communication connection of the first connector. As noted above, HDMI switch 214 includes an input port 204, and HDMI extender 514 includes an input port 504, each being configured to receive HDMI inputs from HDMI source devices. Accordingly, HDMI extender 514 provides a cascaded HDMI input to increase the effective number of input ports available to HDMI switch 214. Additionally, HDMI signals and non-HDMI signals may be exchanged between connected HDMI extenders, such as HDMI extender 514 when connected to another HDMI extender as described herein, as well as between HDMI extender 514 and an HDMI switch, e.g., HDMI switch 214 of FIG. 2. It should be noted here that when HDMI signals and non-HDMI signals are transmitted/received by HDMI extender 514, these signals are transmitted/received between HDMI extenders and/or between an HDMI extender and an HDMI switch using the described connectors, e.g., connector 502 and/or connector 506, rather than HDMI input ports, e.g., input port 504. In embodiments, controller circuit 510 is configured to provide configuration and/or control signals, received thereby from an HDMI controller, to HDMI extenders (e.g., as pass-through or pass-along signals), and/or to receive configuration and/or control signals from HDMI extenders, in embodiments.

Referring to flowchart 800, in step 802, the configuration information received by the HDMI extender is determined at the switching device based on at least one of an HDMI signal or a non-HDMI signal provided from the HDMI extender via the first connector. For example, in embodiments, the configuration information may include at least one of a number of devices coupled to the switching device, a current state of a device coupled to the switching device, a physical address of each of the devices coupled to the switching device, or a logical address of each of the devices coupled to the switching device. An HDMI switch (i.e., a switching device, such as HDMI switch 214 of FIG. 2) may determine the configuration information based on HDMI signals received at HDMI input ports of the HDMI switch, based on HDMI signals received at HDMI input ports of an HDMI extender (e.g., HDMI extender 514) provided via connector thereof (e.g., connector 506), and/or based on non-HDMI signals provided via connector of an HDMI extender (e.g., connector 506).

In step 604 of flowchart 600, the HDMI extender is configured based on the configuration information. For instance, HDMI controller 212 of HDMI switch 214 in FIG. 2 may provide configuration information via connector 202 to HDMI extender 514 via connector 506. Controller circuit 510 may be one component of HDMI extender 514 that is configured according to the configuration information. As similarly described for controller circuit 210 in FIG. 2 above, controller circuit 510 may be a microcontroller, a microprocessor executing software, a system on a chip (SoC), application-specific integrated circuit (ASIC) or other integrated circuit (IC), field-programmable gate array (FPGA), and/or the like, that manages HDMI functionality for each HDMI extender 514 (and/or source device coupled thereto) coupled to an HDMI switch, e.g., such as HDMI switch 214, including multiple HDMI extenders 514 cascaded to provide a plurality of HDMI inputs to an HDMI switch. Additionally, in embodiments, controller circuit 510 may include processing and memory components.

Controller circuit 510 is configured to enable and/or regulate HDMI functionalities associated with HDMI extender 514. Information received in configuration and/or control signals may be stored by controller circuit 510 to configure HDMI extender 514 to properly handle HDMI functionality of coupled devices, as well as to map functionality, configurations, and/or states of coupled devices and other downstream HDMI extenders connected further from an HDMI switch in cascaded connection. Accordingly, HDMI extenders as described herein, such as HDMI extender 514, may be configured to handle HDMI functionalities for specific HDMI sources connected thereto based on the configuration and/or control signals.

As noted above, examples of HDMI functionalities include, but are not limited to, +5V detection (which may be used to determine if a source device is connected and/or powered on), HPD, physical address allocation (which may be unique for every connected source device for CEC to function), EDID handling, CEC functionality (e.g., active source signal handling, remote pass through signal handling, etc.), device information retrieval via CEC (e.g., using Vendor ID or OSD name), DDC (e.g., for exchanging capabilities between source and sink devices), etc. It is noted that the HDMI functionalities associated with each HDMI extender may not be mutually exclusive with respect to each other, and one or more HDMI extenders may have functionalities serviced simultaneously.

In the context of step 604 of flowchart 600 in FIG. 6, as different types of HDMI source devices, and similar types of HDMI source devices from different manufacturers, may require unique handling of HDMI functions, each HDMI extender 514 may be configured, e.g., by configuring controller circuit 510 as described herein, specifically for an HDMI source device connected thereto via input port 504.

HDMI extender 514 is also configured to report the status of devices in the HDMI chain (i.e., HDMI source devices connected to input ports 504 via HDMI cables, as well as other HDMI extenders 514) to the HDMI switch 214 of FIG. 2 and to any other HDMI extenders 514 via the control lines. For example, when HDMI extender 514 is coupled to HDMI switch 214, the current state of the cascaded HDMI device chain (e.g., the number of devices connected, the physical and/or logical addresses of the devices, and the current active input source) is exchanged between one or more devices in the HDMI device chain (e.g., between HDMI switch 214 and HDMI extenders 514 coupled thereto). In embodiments, this information may be used to auto-configure the state of HDMI extenders 514, as well as the HDMI source device connected to (or to be connected to) the HDMI extenders 514.

As noted, HDMI extender 514 includes HDMI signal lines, which may comprise transition-minimized differential signaling (TMDS) corresponding to HDMI signal lines for Input 1 and Input 2. Other signal lines (+5V, HPD, CEC, and DDC lines) from the HDMI input connector are coupled to the micro controller. In embodiments, +5V, HPD, CEC, and DDC lines may be provided from input port 504 to controller circuit 510 via source device detector 512, while in some embodiments, CEC and DDC lines may be provided from input port 504 to controller circuit 510 without being received by source device detector 512. As shown, Control lines may include configuration and control information to be passed between HDMI extenders and an HDMI switch, and although CEC/DDC lines are shown separately for illustration, CEC/DDC lines and Control lines may comprise a single bus.

Controller circuit 510 may include software and/or logic that may be configured to handle CEC issues and/or functions when multiple CEC devices are in a cascaded HDMI device chain, as described herein. For example, Controller circuit 510 may be configured for the “cutting off” (i.e., disconnection) of any undesirable HDMI source devices from the CEC chain (e.g., a source device that transmits an improper message), such as, but not limited to, sanitizing and/or acting upon messages between any of the HDMI sources devices and/or HDMI extenders that are left connected to the cascaded chain. In accordance CEC handling embodiments, HDMI source devices may be grouped and may be isolated, i.e., as a proxy with an input cluster configuration. In accordance with such an embodiment, the messages transmitted by an HDMI source device may be fully acted upon (e.g., monitored, passed, interpreted, filtered and/or blocked) by controller circuit 510 of HDMI extender 514. For instance, each cluster of HDMI source devices may be coupled to its controller circuit 510 via a separate control line (e.g., a CEC line. This configuration addresses the CEC limitation of not having more than three devices of a particular type that can be controlled, thereby providing a system in which all devices in the chain are uniquely identifiable and controllable with the assistance of a proxy (i.e., controller circuit 510).

In embodiments, controller circuit 510 may also be configured to handle problems arising from typical CEC chain solutions such as, but without limitation, continuous active sources, incorrect active sources, and/or controlling source devices having an unregistered logical address.

Additional details regarding the handling of such CEC issues and/or functions may be found in U.S. application Ser. No. 15/475,919 (entitled, “Method and Apparatus for Implementing HDMI CEC”), the entirety of which is incorporated by reference herein.

Referring now to FIG. 9, a flowchart 900 is shown, according to example embodiments. For purposes of illustration, flowchart 900 is described with respect to HDMI extender 514 of FIG. 5 and its subcomponents, and also with reference to HDMI switch 214 in FIG. 2. That is, HDMI extender 514 of FIG. 5 may perform various functions and operations in accordance with flowchart 900 for cascading HDMI inputs as described herein. Further structural and operational examples will be apparent to persons skilled in the relevant art(s) based on the following description. Flowchart 900 is described as follows.

In step 902, a selector of the HDMI extender is configured to provide a first signal path from the first HDMI input port or a second signal path from a second connector of the HDMI extender. For example, input switch circuit 508, i.e., a selector, may be configured according a control signal from controller circuit 510 to provide a signal path from input port 504 or a signal path from connector 502 of HDMI extender 514 to connector 506, according to embodiments. That is, connector 502 is communicatively coupled to connector 506 via input switch circuit 508, and input port 504 is communicatively coupled to connector 506 via input switch circuit 508.

In step 904, an HDMI signal is provided, subsequent to configuring the selector of the HDMI extender, via the selector and the first connector from one of the first HDMI input port or the second connector. For instance, after configuring input switch circuit 508 in step 902, a path for an HDMI signal is provided by input switch circuit 508 to connector 506. The path may provide HDMI signals from either of connector 502 (Input 2) or input port 504 (Input 1) based on the configuring of input switch circuit 508.

Referring back to flowchart 300 of FIG. 3 described above, an HDMI extender such as HDMI extender 514 of FIG. 5, may also be configured to perform its various functions and operations in accordance with flowchart 300, as described in this subsection. For instance, an HDMI input port such as input port 504 may be configured to receive first HDMI signals, and connector 502 may be configured to receive second HDMI signals, and to transmit non-HDMI signals. Additionally, controller circuit 510 may be configured to receive the non-HDMI signals, and control operations of input switch circuit 508 according to a control signal based at least in part on the non-HDMI signals. For instance, controller circuit 510 is configured to control the activation of input switch circuit 508. Controller circuit 510 may utilized configuration and/or control signals to activate and/or deactivate input switch circuit 508 via a switch control signal (SwCtrl). Input switch circuit 508 may be configured to provide switch output signals via connector 506 as one of the first HDMI signals received from input port 504 or the second HDMI signals received from connector 502. For example, based on received configuration and/or control information, an HDMI controller such as HDMI controller 212 may determine that an HDMI source connected at input port 504 is active and/or selected for operation by a user, and a control signal to this effect may be provided to controller circuit 510 which in turn provides an appropriate switch control signal SwCtrl to input switch circuit 508 to activate input switch circuit 508 for a signal path from input port 504 to connector 506 for Input 1, via input switch circuit 508, for transmission to HDMI switch 514. In other embodiments, based on received configuration and/or control information, HDMI controller 212 may determine that an HDMI source connected via connector 502 and an input port of another HDMI extender is active and/or selected for operation by a user, and a control signal to this effect may be provided to controller circuit 510 which in turn provides an appropriate switch control signal SwCtrl to input switch circuit 508 to activate input switch circuit 508 for a signal path from connector 502 to connector 506 for Input 2, via input switch circuit 508, for transmission to HDMI switch 514.

According to the described embodiments and techniques, providing and receiving control and configuration information (e.g., non-HDMI signals) to/from HDMI input extenders via connector 502 and 504 for HDMI extenders such as HDMI extender 514 may be accomplished according to various communication standards and signaling, as similarly noted in the subsection above. Example implementations to provide and receive such non-HDMI signals for the control and configuration information include, but are not limited to, standard communication buses, such as inter-integrated circuit (I2C) buses, universal asynchronous receiver/transmitter (UART), serial peripheral interface (SPI) buses, etc., and controller circuit 510 is configured to provide and receive non-HDMI signals using these protocols. In accordance with another embodiment, the non-HDMI control signals may be transmitted and/or received via a wireless connection (e.g., Bluetooth®, Wi-Fi®, ZigBee®, and/or any other radio-frequency (RF) based on a wireless communication protocol (as opposed to using a wired communication protocol).

Connector 502 is configured to be coupled another HDMI extender that includes an HDMI input port. Connector 502 and connector 506 may be configured to mechanically couple/decouple from other HDMI extenders, and connector 506 be configured to mechanically couple/decouple from an HDMI switch, such as HDMI switch 214, providing flexibility to cascade any number of HDMI extenders to HDMI switch 214.

As noted, HDMI extender system 500 also includes source device detector 512. In embodiments, source device detector 512 comprises circuitry that is configured to detect the presence/absence of an HDMI source device connected to input port 504. In some embodiments, at least one portion of source device detector 512 circuity is included in, and/or is part of, controller circuit 510, while in other embodiments, the entirety of the source device detector 512 circuity may be included in controller circuit 510 instead of being included in circuitry external to controller circuit 510 as in the illustrated embodiment.

FIG. 10 shows a flowchart 1000 for source device detection, according to example embodiments. For purposes of illustration, flowchart 1000 is described with respect to HDMI extender 514 of FIG. 5 and its subcomponents. That is, HDMI extender 514 of FIG. 5 may perform various functions and operations in accordance with flowchart 1000 for source device detection as described herein. Further structural and operational examples will be apparent to persons skilled in the relevant art(s) based on the following description. Flowchart 1000 is described as follows.

In step 1002, the presence of an HDMI source device on the HDMI input port is detected. For instance, source device detector 512 circuitry may include circuitry configured to determine if an HDMI source device is present (i.e., a presence state) at input port 504, according to embodiments, and may also be configured to determine if an HDMI source device is powered on, is in stand-by mode, or is powered off when present. Source device detector 512 circuitry may be configured to determine a presence state by utilizing a voltage divider circuit (e.g., utilizing capacitive divider action), according to embodiments.

For example, according to the HDMI Specification, a +5V signal is provided by a source device over an HDMI connection (i.e., an HDMI cable connected to an input port) whenever the source device is connected to a sink device and is active or in an ON state. As previously noted, to the extent an HDMI source may be connected to HDMI extender 514 via input port 504, HDMI extender 514 acts as a sink device in this capacity. However, when +5V is not present on the input port of the sink, this case can imply three different scenarios: 1) the source device is switched OFF; 2) the source device is in standby; or 3) the HDMI cable between the source device and the sink device is disconnected. The techniques and embodiments herein allow for leveraging capacitive divider action, for example, between a known or previously measured capacitance of a combination of, e.g., HDMI extender 514, the HDMI cable, and the HDMI source device, and the capacitances of a capacitive voltage divider.

In step 1004, an indication of the presence is provided to the controller circuit. For example, using associated voltage division for the capacitive voltage divider as described in step 1002, a clear logic signal may be triggered for source device detector 512 to make a determination of an HDMI source presence state. A signal(s) indicative of the presence state may then be provided from source device detector 512 to controller circuit 510, where the presence state may be stored and utilized, as well as provided to other HDMI extenders and/or HDMI switches for configuration and/or storage purposes.

The HDMI source device detection techniques, and associated components and/or circuits such as those of source device detector 512, may be rendered inactive or idle when an HDMI source device is detected and connected, and may be active otherwise.

Additional details regarding the source device detection circuity may be found in U.S. application Ser. No. 15/398,405 (entitled, “Source Device Detection”), the entirety of which is incorporated by reference herein.

C. Additional Example Multi-Cascade Embodiments

FIG. 11 is a block diagram of an HDMI system 1100 that includes an HDMI switch coupled to a plurality of cascaded HDMI extenders, in accordance with an embodiment. System 1100 of FIG. 11 may be a further embodiment of system 100 of FIG. 1, HDMI system 200 of FIG. 2, and/or HDMI extender system 500 of FIG. 5. As shown in FIG. 11, an instance of HDMI switch 214, and two instances of HDMI extender 514 are shown, mechanically and communicatively coupled, thereby effectively turning the one-input HDMI switch (HDMI switch 214) to a three-input HDMI switch (an HDMI switch 1110). It is noted that while FIG. 11 only shows two instances of HDMI extender 514 coupled to HDMI switch 214, any number of instances of HDMI extender 514 may be coupled to HDMI switch 214 in a cascade, according to embodiments.

For clarity and brevity, the instance of HDMI switch 214 and the two instances of HDMI extender 514 are shown with illustrative simplicity and without each components/subcomponents specifically labeled or included in FIG. 11 as such labels and components/subcomponents are provided in FIGS. 2 and 5, and described above.

As shown in FIG. 11, HDMI switch 214 supports an input connection at its input port for an HDMI source 1 device 1102, and supports an output connection at its output port for an HDMI sink device 1108. The first downstream instance of HDMI extender 514 supports an input connection at its input port for an HDMI source 2 device 1104, and the second downstream instance of HDMI extender 514 supports an input connection at its input port for an HDMI source 3 device 1106. Accordingly, multiple effective inputs for HDMI switch 214, to be provided to HDMI sink device 1108, are realized through cascaded HDMI extenders 514 without sacrificing HDMI functionality for any of the connected HDMI inputs.

That is, according to the described embodiments and techniques, even while separate and detachable HDMI extenders are utilized to cascade inputs, through the configuration of controller circuits, e.g., controller circuit 510, to handle HDMI functionality for specific HDMI source devices connected to cascaded HDMI extenders 514, any of the HDMI source devices at any point downstream in the cascaded chain may be configured to properly handle HDMI functions and to provide control/configuration information (non-HDMI signals), in addition to HDMI signals, to the HDMI switch, HDMI switch 214.

FIG. 12 shows a flowchart 1200 for cascading HDMI inputs, according to example embodiments. For purposes of illustration, flowchart 1200 is described with respect to HDMI extender 514 of FIG. 5 and its subcomponents, as well HDMI switch 214 of FIG. 2. That is, HDMI extender 514 of FIG. 5 may perform various functions and operations in accordance with flowchart 1200 for source device detection as described herein. Flowchart 1200 may be a further embodiment of flowchart 700 of FIG. 7. Further structural and operational examples will be apparent to persons skilled in the relevant art(s) based on the following description. Flowchart 1200 is described as follows.

In step 1202, at least one of the HDMI signal or the non-HDMI signal is originally provided from another HDMI extender communicatively coupled to the switching device via the HDMI extender. For example, in step 702 of flowchart 700 in FIG. 7, HDMI signals and non-HDMI signals are provided between the switching device and the HDMI extender via a communication connection of the first connector in a wired or wireless manner. As noted above, HDMI switch 214 includes an input port 204, and HDMI extender 514 includes an input port 504, each being configured to receive HDMI inputs from HDMI source devices. Additionally, HDMI signals and non-HDMI signals may be exchanged between connected HDMI extenders, such as HDMI extender 514 when connected to another HDMI extender as described herein, as well as between HDMI extender 514 and an HDMI switch, e.g., HDMI switch 214 of FIG. 2. It should be noted here that when HDMI signals and non-HDMI signals are transmitted/received by HDMI extender 514, these signals are transmitted/received between HDMI extenders and/or between an HDMI extender and an HDMI switch using the described connectors, e.g., connector 502 and/or connector 506 as shown in FIG. 5, rather than HDMI input ports, e.g., input port 504. In embodiments, controller circuit 510 of an instance of HDMI extender 514 is configured to provide configuration and/or control signals, received thereby from an HDMI controller, to HDMI extenders (e.g., as pass-through or pass-along signals), and/or to receive configuration and/or control signals from other cascaded HDMI extenders, in embodiments.

In other words, in step 1202, HDMI signals and/or non-HDMI signals may be originally provided to a first instance of HDMI extender 514 from any other instance of HDMI extender 514 that further downstream or upstream in the cascaded chain when communicatively coupled to the first instance of HDMI extender 514. Thus, in embodiments, the first instance of HDMI extender 514 in FIG. 11 that is directly connected to HDMI switch 214 may also provide HDMI switch 214 with HDMI signals and/or non-HDMI signals from an indirectly-connected instance of HDMI extender 514 because all instances of HDMI extender 514 are connected to HDMI switch 214, be it by direct or indirect connections.

Furthermore, as noted herein, connectors may be configured to communicate in wired or wireless manners as shown in a wireless connection 1112. As used herein, a wired connection includes, but is not limited to, a connection using cables, wires, pins, and/or any other type of conductive connector element.

### III. Further Example Embodiments and Advantages

As noted above, circuits, systems, and devices may be configured in various ways for cascading HDMI inputs to provide any number of additional inputs to an HDMI switch and/or HDMI sink, according to the techniques and embodiments provided. For example, embodiments and techniques, including methods, described herein may be performed in various ways such as, but not limited to, being implemented by hardware, or hardware combined with one or both of software and firmware. For example, embodiments may be implemented as systems and devices, such as HDMI systems, schemes, setups, and devices, specifically customized hardware, ASICs, SoCs, FPGAs, controller circuits, mixed-signal circuits, logic and circuits on a printed circuit board (PCB) (e.g., with discrete components) or a on semiconductor substrate, other electrical circuitry, and/or the like.

In accordance with embodiments, any combination of the above-described embodiments may be utilized depending on the system being implemented. For example, while the embodiments and techniques herein are largely described with reference to a switching device, such as an HDMI switch, embodiments may also be implemented in other devices (e.g., sink devices).

It should also be noted that for HDMI switches and/or HDMI sinks having more than one connector for HDMI extenders, a cascade of HDMI extenders may be used for each connector. For example, an HDMI switch or HDMI sink having four connectors may support up to four HDMI extender cascades in parallel.

It is also contemplated herein that the timing for configuring one or more HDMI extenders may be performed such that an HDMI extender for which a connected HDMI source will be active and providing an HDMI signal for a sink device may be the final HDMI extender in a cascaded connection whose input switch circuit is activated so as to avoid signaling conflicts with other connected source devices. Furthermore, in embodiments, HDMI extenders and/or HDMI switches that are not connected to HDMI source devices or are connected to HDMI source devices that are not active may be configured with a NO input switch circuit configuration that provides a connector-to-connector path instead of an HDMI input port-to-connector path.

Multiple instances of HDMI extenders, such as HDMI extender 102 and HDMI extender 514, may be combined in embodiments to form multi-input port HDMI extenders. In such combinations, common components may be shared, and circuit-specific components may be isolated from each other for individual operations of the described circuits, systems, and devices. It is also contemplated that multiple instances of the circuits, systems, and devices described herein may be included in other circuits, systems, and devices. That is, embodiments provide for HDMI extenders with multiple HDMI input ports (e.g., 2, 3, 4, . . . , 8, etc.) having connectors configured for the exchange of HDMI and non-HDMI signals for such embodiments.

In embodiments, one or more of the steps and/or operations of any flowchart described herein may not be performed. Moreover, operations in addition to or in lieu of any flowchart described herein may be performed. Further, in embodiments, one or more operations of any flowchart described herein may be performed out of order, in an alternate sequence, or partially (or completely) concurrently with each other or with other operations.

The further example embodiments and advantages described in this Section may be applicable to embodiments disclosed in any other Section of this disclosure.

### IV. Example Computer System Implementation

Various components of the systems, devices, circuits, and/or processes shown in FIGS. 1-12 and described in embodiments may be implemented in hardware, or any combination of hardware with software and/or firmware. For example, various embodiments described, e.g., with respect to the Figures, may be implemented as computer program code configured to be executed in one or more processors, processing units, processing devices, processing circuits, integrated circuits, programmable circuits, and/or controllers. In another example, various embodiments described herein may be implemented as hardware (e.g., chips, hardware logic, electrical circuitry, etc.), or any combination of hardware with software (computer program code configured to be executed) and/or firmware.

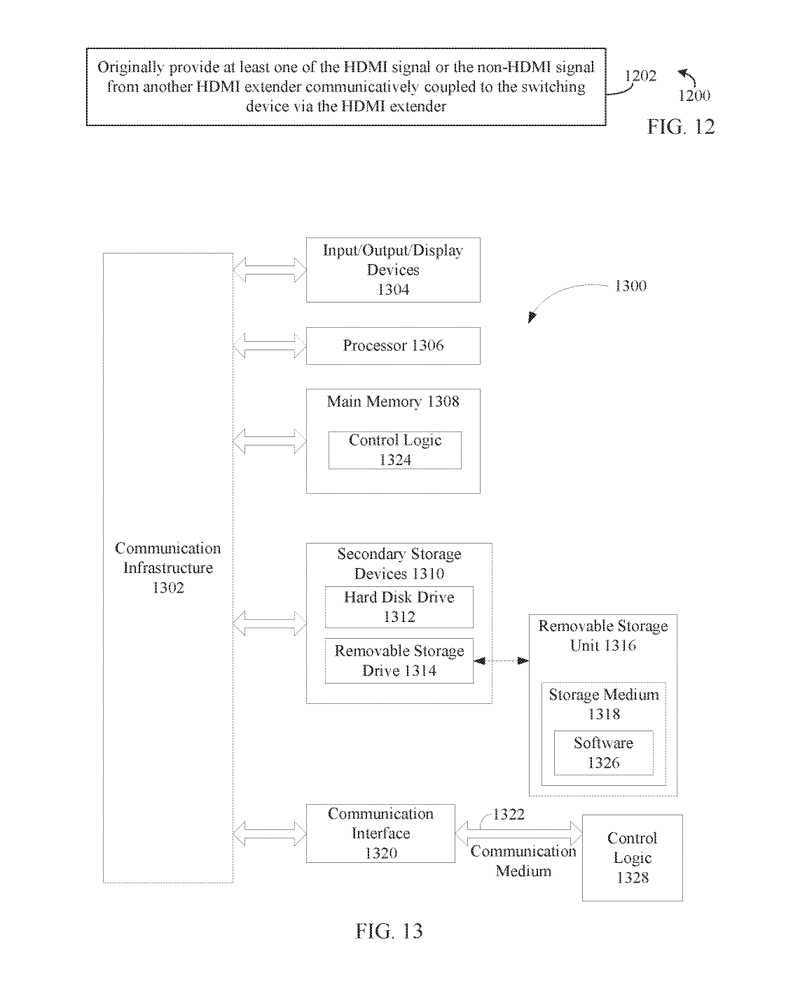

The embodiments described herein, including systems, devices, circuits, methods/processes, and/or apparatuses, may be implemented using well-known servers/computers, such as processing device 1300 shown in FIG. 13, having adaptations according to the embodiments. For example, various systems, devices, circuits, and/or processes shown in FIGS. 1-12 and described herein may each be implemented using one or more processing devices 1300.

For example, various features of the circuits, devices, and systems described herein, including but without limitation, system 100, HDMI system 200 of FIG. 2, HDMI extender system 400 of FIG. 4, HDMI extender system 500 of FIG. 5, and HDMI system 1100 of FIG. 11, along with various features of any respective components and/or subcomponents thereof, and/or any techniques, flowcharts, further systems, sub-systems, and/or components disclosed and contemplated herein, may be implemented in hardware, or in any combination of hardware with one or both of software (computer program code or instructions configured to be executed in one or more processors or processing devices, etc.) and firmware.

The embodiments and techniques described herein may also be implemented in or using other well-known processing devices, as well as servers and/or computers as noted above, such as a processing device 1300 shown in FIG. 13. That is, it should be noted that processing device 1300 may represent communication devices/systems, entertainment systems/devices, HDMI-enabled devices, other processing devices, as well as tablets, laptops and/or traditional computers in one or more embodiments. For example, systems, devices, circuits, etc., for cascading HDMI inputs according to the described techniques and embodiments, and any of the sub-systems and/or components respectively contained therein and/or associated therewith, may be implemented in or using one or more processing devices 1300 and/or other computing devices.

Processing device 1300 can be any commercially available and well-known communication device, processing device, and/or computer capable of performing the functions described herein, such as, but not limited to, devices/computers available from International Business Machines®, Apple®, Sun®, HP®, Dell®, Cray®, Samsung®, Nokia®, etc. Processing device 1300 may be any type of computer, including a desktop computer, a server, etc., and may be a computing device or system within another device or system.

Processing device 1300 includes one or more processors (also called central processing units, or CPUs), such as a processor 1306. Processor 1306 is connected to a communication infrastructure 1302, such as a communication bus. In some embodiments, processor 1306 can simultaneously operate multiple computing threads, and in some embodiments, processor 1306 may comprise one or more processors.

Processing device 1300 also includes a primary or main memory 1308, such as random access memory (RAM). Main memory 1308 has stored therein control logic 1324 (computer software), and data.

Processing device 1300 also includes one or more secondary storage devices 1310. Secondary storage devices 1310 include, for example, a hard disk drive 1312 and/or a removable storage device or drive 1314, as well as other types of storage devices, such as memory cards and memory sticks. For instance, processing device 1300 may include an industry standard interface, such as a USB interface for interfacing with devices such as a memory stick. Removable storage drive 1314 represents a floppy disk drive, a magnetic tape drive, a compact disk drive, an optical storage device, tape backup, etc.

Removable storage drive 1314 may interact with a removable storage unit 1316. Removable storage unit 1316 includes a computer useable or readable storage medium 1318 having stored therein computer software 1326 (control logic) and/or data. Removable storage unit 1316 represents a floppy disk, magnetic tape, compact disk, DVD, optical storage disk, or any other computer data storage device. Removable storage drive 1314 reads from and/or writes to removable storage unit 1316 in a well-known manner.

Processing device 1300 also includes input/output/display devices 1304, such as touchscreens, LED and LCD displays, monitors, keyboards, pointing devices, etc.

Processing device 1300 further includes a communication or network interface 1320. Communication interface 1320 enables processing device 1300 to communicate with remote devices. For example, communication interface 1320 allows processing device 1300 to communicate over communication networks or mediums 1322 (representing a form of a computer useable or readable medium), such as LANs, WANs, the Internet, etc. Communication interface 1320 may interface with remote sites or networks via wired or wireless connections.

Control logic 1328 may be transmitted to and from processing device 1300 via the communication medium 1322.

Any apparatus or manufacture comprising a computer useable or readable medium having control logic (software) stored therein is referred to herein as a computer program product or program storage device. This includes, but is not limited to, processing device 1300, main memory 1308, secondary storage devices 1310, and removable storage unit 1316. Such computer program products, having control logic stored therein that, when executed by one or more data processing devices, cause such data processing devices to operate as described herein, represent embodiments.

Techniques, including methods, and embodiments described herein may be implemented by hardware (digital and/or analog) or a combination of hardware with one or both of software and/or firmware. Techniques described herein may be implemented by one or more components. Embodiments may comprise computer program products comprising logic (e.g., in the form of program code or software as well as firmware) stored on any computer useable medium, which may be integrated in or separate from other components. Such program code, when executed by one or more processor circuits, causes a device to operate as described herein. Devices in which embodiments may be implemented may include storage, such as storage drives, memory devices, and further types of physical hardware computer-readable storage media. Examples of such computer-readable storage media include, a hard disk, a removable magnetic disk, a removable optical disk, flash memory cards, digital video disks, random access memories (RAMs), read only memories (ROM), and other types of physical hardware storage media. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, flash memory cards, digital video discs, RAM devices, ROM devices, and further types of physical hardware storage media. Such computer-readable storage media may, for example, store computer program logic, e.g., program modules, comprising computer executable instructions that, when executed by one or more processor circuits, provide and/or maintain one or more aspects of functionality described herein with reference to the figures, as well as any and all components, capabilities, and functions therein and/or further embodiments described herein.

Such computer-readable storage media are distinguished from and non-overlapping with communication media, software programs, and transitory signals (do not include communication media, software programs, or transitory signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media and signals transmitted over wired media. Embodiments are also directed to such communication media.

The techniques and embodiments described herein may be implemented as, or in, various types of devices. For instance, embodiments may be included, without limitation, in processing devices (e.g., illustrated in FIG. 13) such as computers and servers, as well as communication systems such as switches, routers, gateways, and/or the like, communication devices such as smart phones, home electronics, gaming consoles, entertainment devices/systems, etc. A device, as defined herein, is a machine or manufacture as defined by 35 U.S.C. §101. That is, as used herein, the term “device” refers to a machine or other tangible, manufactured object and excludes software and signals. Devices may include digital circuits, analog circuits, or a combination thereof. Devices may include one or more processor circuits (e.g., central processing units (CPUs), processor 1306 of FIG. 13), microprocessors, digital signal processors (DSPs), and further types of physical hardware processor circuits) and/or may be implemented with any semiconductor technology in a semiconductor material, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

### V. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A method in a high-definition multimedia interface (HDMI) system, comprising:
receiving configuration information from a switching device coupled to an HDMI extender via a first connector, the HDMI extender comprising a first HDMI input port and the switching device comprising a second HDMI input port; and
configuring the HDMI extender based on the configuration information.

2. The method in the HDMI system of claim 1, further comprising:
providing HDMI signals and non-HDMI signals between the switching device and the HDMI extender via a communication connection of the first connector.

3. The method in the HDMI system of claim 1, wherein the configuration information comprises at least one of:
a number of devices coupled to the switching device;
a current state of a device coupled to the switching device;
a physical address of each of the devices coupled to the switching device; or
a logical address of each of the devices coupled to the switching device.

4. The method in the HDMI system of claim 1, wherein the configuration information is determined at the switching device based on at least one of an HDMI signal or a non-HDMI signal provided from the HDMI extender via the first connector.

5. The method in the HDMI system of claim 4, wherein the at least one of the HDMI signal or the non-HDMI signal originates from another HDMI extender communicatively coupled to the switching device via the HDMI extender.

6. The method in the HDMI system of claim 1, wherein configuring the HDMI extender comprises:
configuring a selector of the HDMI extender to provide a first signal path from the first HDMI input port or a second signal path from a second connector of the HDMI extender; and
providing, subsequent to configuring the selector of the HDMI extender, an HDMI signal via the selector and the first connector from one of the first HDMI input port or the second connector.

7. The method in the HDMI system of claim 6, wherein the HDMI signal is transmitted from an HDMI source device connected to another HDMI input port of another HDMI extender that is communicatively and mechanically coupled to the HDMI extender via the second connector.

8. A high-definition multimedia interface (HDMI) device, comprising:
an HDMI input port configured to receive first HDMI signals;
a first connector configured to receive second HDMI signals, and to transmit non-HDMI signals;
an input switch circuit configured to provide switch output signals as one of the first HDMI signals received from the HDMI input port or the second HDMI signals received from the first connector; and
a controller circuit configured to:
receive the non-HDMI signals; and
control operations of the input switch circuit according to a control signal
based at least in part on the non-HDMI signals.

9. The HDMI device of claim 8, wherein the HDMI device comprises an HDMI extender, and
wherein the first connector is configured to receive the non-HDMI signals;
the HDMI device further comprising:
a second connector configured to:
receive and transmit the non-HDMI signals; and
transmit the switch output signals.

10. The HDMI device of claim 9, wherein the controller circuit is configured to control operations of the input switch circuit based on the control signal by:
generating the control signal; and
providing the control signal to the input switch circuit to activate to provide the switch output signals according to the control signal.

11. The HDMI device of claim 9, wherein the controller circuit is configured to:
receive configuration information as one of the non-HDMI signals, the configuration information including at least one of:
a number of devices coupled to the switching device;
a current state of a device coupled to the switching device;
a physical address of each of the devices coupled to the switching device;
or
a logical address of each of the devices coupled to the switching device;
and
set one or more portions of the controller circuit to operate according to the configuration information.

12. The HDMI device of claim 8, further comprising:
source device detection circuitry configured to:
detect a presence of an HDMI source device on the HDMI input port; and
provide an indication of the presence to the controller circuit.

13. The HDMI device of claim 8, wherein the controller circuit is further configured to perform at least one HDMI protocol function based on received configuration information, for an HDMI source device connected to the HDMI input port, including:
+5V detection;
hot plug detection and toggle;
physical address allocation;
extended display identification data handling;
consumer electronics control;
display data channel; or
device information retrieval.

14. The HDMI device of claim 8, wherein the HDMI device comprises an HDMI switch, the HDMI device further comprising:
an HDMI control circuit configured to:
provide the non-HDMI signals to the controller circuit; and
receive the switch output signals; and
an HDMI output port configured to provide the switch output signals for an HDMI sink device.

15. The HDMI device of claim 14, wherein the controller circuit is configured to provide the non-HDMI signals from the HDMI control circuit to one or more HDMI extenders communicatively coupled via the first connector.

16. A high-definition multimedia interface (HDMI) system, comprising:
an HDMI input port; and
at least one processing circuit communicatively coupled to the HDMI input port and configured to:
receive configuration information from an HDMI controller that is external to the HDMI system; and
perform HDMI protocol functions with an HDMI source device connected to the HDMI input port according to the configuration information.

17. The HDMI system of claim 16, further comprising:
a first connector that is communicatively coupled to the at least one processing circuit and to the HDMI input port, the first connector configured to:
enable mechanical coupling and decoupling between the HDMI system and an HDMI switch comprising the HDMI controller; and
provide output HDMI signals to the HDMI switch;
wherein the at least one processing circuit is configured to receive the configuration information via the first connector.

18. The HDMI system of claim 17, further comprising:
a second connector that is communicatively coupled to the at least one processing circuit and to the first connector, the second connector configured to:
enable mechanical coupling and decoupling between the HDMI system and another HDMI system that comprises another HDMI input port; and
receive first HDMI signals from the other HDMI system.

19. The HDMI system of claim 18, wherein the HDMI input port is configured to receive second HDMI signals;
the HDMI system further comprising:
an HDMI signal selector configured to select the first HDMI signals or the second HDMI signals as the output HDMI signals based on a control signal from the at least one processing circuit.

20. The HDMI system of claim 16, further comprising:
a first connector that is communicatively coupled to the at least one processing circuit and to the HDMI input port, the first connector configured to:
enable wireless HDMI communications between the HDMI system and an HDMI switch comprising the HDMI controller to provide an HDMI signal from the HDMI input port to the HDMI switch.
